(19) United States
(12) Patent Application Publication
(10) Pub. No.: US 2003/0176561 A1
(43) Pub. Date: Sep. 18, 2003

(54) One component thermoset polyurethane system

(76) Inventors: Ravi R. Joshi, Auburn Hills, MI (US); Herbert R. Gillis, West Deptford, NJ (US)

Correspondence Address: Patent Counsel, Huntsman Polyurethanes, 286 Mantua Grove Road, West Deptford, NJ, 08066-1732, US

(21) Appl. No.: 10/369,991

(22) Filed: Feb. 18, 2003

Related U.S. Application Data
(63) Continuation of application No. PCT/US01/25907, filed on Aug. 17, 2001.
(60) Provisional application No. 60/226,126, filed on Aug. 18, 2000.

(51) Int. Cl. C08K 3/40

(52) U.S. Cl. 524/494

(57) ABSTRACT

Process for the preparation of fiber reinforced composites in which the matrix polymer is derived from the catalyzed reaction of a liquid polyisocyanate containing material. The principle curing mechanism is the formation of urethane and/or isocyanurate linkages. At least a portion of the catalyst is applied onto the surface of the reinforcing fibers and/or onto the surface to the uncured resin impregnated reinforcing structure, under conditions such that the catalyst is not dispersed into the bulk of the isocyanate containing resin until cure. Curing is facilitated by a combination of mechanical and thermal action. The process is particularly well suited for the preparation of composites by pultrusion, using a one-component open-bath pultrusion machine. The process of the invention may be adapted to a much wider range of composite fabrication methods, including SMC and filament winding.

### CROSS-REFERENCE TO RELATED APPLICATIONS

This application claims the benefit under 35 U.S.C. Section 119(e) of U.S. Provisional Application Serial No. 60/226,126, filed Aug. 18, 2000, entitled “One Component Thermoset Polyurethane System”, the subject matter of which is herein incorporated by reference. This application is also a continuation of international application PCT/US01/25907, filed Aug. 17, 2001.

### TECHNICAL FIELD

This invention relates to a process for forming fiber reinforced composite bodies.

### BACKGROUND ART

Pultrusion is a process that is used to manufacture continuous fiber reinforced linear composite bodies, wherein the fibers are embedded in a matrix polymer. Conventionally, it is done by a one component, open bath process using thermoset resin systems having a gel time ranging from a few hours to days at room temperature. In this process, continuous fibers are dipped through an open liquid resin bath and then pulled through a heated die and cured. The cured composite is then pulled out of the die by a mechanical puller and cut to a desired length by a flying cut-off saw.

Besides such open bath processes, closed, one component liquid resin injection die processes are also used in the pultrusion industry. In these processes the liquid resin is directly injected through a closed die on the reinforcement sheet and then pulled through a heated die and cured. At present, it is believed that more than 90% of the pultrusion industry uses the open liquid resin bath process, which is, currently, the most economical way of making pultruded fiber reinforced composites. Most of the thermoset resin systems currently used in the pultrusion industry are used as solutions in an unsaturated monomer such as styrene or methyl methacrylate (MMA). The monomer reduces the viscosity of the resin and facilitates wetting of the fibers in the open bath. However, due to strict environmental issues (e.g., styrene and MMA emissions, and other health hazards), closed injection pultrusion processes are gaining attention and are being considered as an alternate to the open bath processes. However, to use a closed injection die process, certain modifications in the resin injection unit and dispensing mechanism have to be made to the conventional pultrusion set-up. These closed injection die retrofits can be expensive and, in the case of the conventional styrene or MMA based thermoset systems, may not be totally successful in eliminating monomer emissions and odor problems.

Resins which have been used in the open bath and injection die methods of pultrusion include thermoset resins such as unsaturated polyester, epoxy, phenolics, methacrylates and the like, as well as thermoplastic resins such as PPS, ABS, and Nylon 6. Blocked polyurethane prepolymers also have been used.

The idea to use polyurethane resin systems (thermoset and thermoplastic) in pultrusion has been attempted in the last several years. However, due to the nature of the thermoset chemical reaction (e.g., fast reaction kinetics, short gel time, release of exothermic energy during the reaction, processing difficulties such as freezing of the line, bath and die, etc.); open bath pultrusion process utilizing an un-blocked (free isocyanate containing) liquid polyurethane thermoset resin system have not been industrially successful. Two component polyurethane systems have been used, to a very limited degree. But such two component urethane type systems generally have required the use of a two component closed injection die, with provision for precise and continuous control of the ratios of the two components and adequate mixing thereof during the injection process. The engineering and cost considerations of such complex two component thermoset technology has limited the industry.

Polyurethane and polyisocyanurate systems offer potential advantages over the resins commonly used in thermoset pultrusion processes today. These advantages include low volatility, low odor, and low emissions. Additional advantages include improved composite properties and heat resistance (particularly for the polyurethane-polyisocyanurate matrix resins). Polyurethane and urethane-isocyanurate systems based on MDI series polyisocyanates are particularly advantageous in this regard. Volatile monomers, such as styrene and MMA, are not required in these systems. As such, closed injection die processes would not be required in order to control emissions.

Therefore, a strong need exists for a process that can facilitate the open bath pultrusion of polyurethane and polyurethane-polyisocyanurate thermosetting composite systems, without the need of expensive retrofitting of equipment. Any such improved process, to be successful in industry, must provide for adequate wetting of the long fiber reinforcing material in the open bath, and for homogeneous curing of the resin treated fibers within the curing die. Premature gelling of the resin, curing inhomogeneities (i.e. wet spots), and excessively slow line speeds (due to extended fiber wet-out times, or long cure times) must be avoided.

### DISCLOSURE OF THE INVENTION

An aspect of the invention relates to a method of forming a fiber reinforced polyurethane or polyisocyanurate-urethane composite by a one component open bath polyurethane resin pultrusion process. The process comprises the steps of: under substantially moisture free conditions, treating reinforcing fibers with a polyisocyanate material (polyisocyanate resin) in an open bath; removing the fibers from the bath; treating the polyisocyanate treated fibers with a catalyst; and pulling the reinforcing fibers through a heated die to form a fiber reinforced composite. The polyisocyanate material may optionally contain unreacted polyfunctional active hydrogen materials, such as polyols, dissolved or dispersed therein. Alternatively, the fibers may be treated with the catalyst before treatment with the polyisocyanate material, under the proviso that the catalyst remains in a separate phase until the fibers are heated. Here again, the polyisocyanate material may optionally contain unreacted polyfunctional active hydrogen materials, such as polyols, dissolved or dispersed therein. The processing principle described herein for one-component pultrusion may be extended to other types of reinforced thermoset composites, such as sheet molding compounds (SMC), filament winding, wet layup process, resin transfer molding (RTM), and other processes based on polyurethane or polyisocyanurate-urethane materials. In a particularly preferred embodiment of the invention, the polyisocyanate material contains an isocyanate terminated prepolymer and is free of unreacted polyfunctional active hydrogen species, such as polyols; and the cured composite is a polyisocyanurate-urethane composite. Pultrusion is a particularly preferred processing mode for this embodiment.

### BRIEF DESCRIPTION OF THE FIGURE

FIG. 1 is a schematic drawing of an apparatus according to the present invention.

### BEST MODES FOR CARRYING OUT THE INVENTION

The treating of the fibers is accomplished utilizing any suitable diisocyanate- or polyisocyanate-containing material (hereinafter collectively referred to as isocyanate-containing material). The term polyisocyanate as used herein is understood to encompass diisocyanates. Typically, the isocyanate-containing material is a mixture of isocyanates (prepolymers, polymeric MDI and pure MDI in various ratios). Isocyanate containing materials comprising prepolymers are preferred. The isocyanate-containing material can additionally include, for example, non-reactive inert components such as additives, fillers, internal mold release agents, diluents etc. Finally, the isocyanate containing material may optionally include unreacted (or partly reacted) polyfunctional active hydrogen compounds, such as polyols; under the proviso that these unreacted active hydrogen species do not cause premature gelling of the isocyanate containing material, the isocyanate containing material contains free isocyanate (—NCO) groups at least until it enters the curing die (or mold), and the viscosity of the isocyanate containing material is such that the reinforcing fibers can be adequately impregnated and wetted in the open bath. The optional polyfunctional active hydrogen containing compounds may contain minor amounts of monofunctional active hydrogen species in admixture therewith. A preferred mode of the invention is to use an isocyanate containing material which is substantially free of such unreacted active hydrogen containing compounds, regardless of their functionality, and most preferably entirely free of such compounds.

The isocyanate containing material is a liquid under the conditions used for impregnation of the fibrous reinforcement material, and is preferably also liquid at a storage temperature of 25° C.

The term “open bath” as used herein will refer to a bath used for impregnating a fibrous reinforcing material with the liquid isocyanate containing material, wherein the bath contains the isocyanate containing material at the bottom and a gas filled head space above the isocyanate containing material. The gas or gas mixture in the head space is in direct contact with the isocyanate containing material. The gas, or gas mixture, in the gas filled head space is preferably at ambient atmospheric pressure. The open bath preferably does not require means for applying pressure to the isocyanate containing material, although it may contain one or more means for the agitation of the material. The open bath may optionally also contain means for controlling the composition of the gas or gas mixture in the head space above the isocyanate. The open bath may optionally also contain rollers, doctor blades, brushes, or other means for controlling the flow of the fibrous reinforcing material through the liquid isocyanate containing material and for the recycle of excess isocyanate containing material back into the bath. Accordingly, the open bath apparatus may also contain means for the transport and recirculation of liquid isocyanate containing material. It is a feature of the invention, however, that the application of pressure, requiring a closed chamber in the absence of gas filled head space (as in a closed impregnation die) is not needed to achieve suitable impregnation and wetting of the fibrous reinforcing material.

The treating step includes providing the liquid isocyanate-containing material in the open bath, with the atmosphere contacting the bath substantially free from moisture. What is meant by “substantially free from moisture” is that the atmosphere in contact with the isocyanate-containing material is free from an amount of moisture, which would cause premature reaction of the isocyanate material.

The open bath may comprise a cover enclosing both the isocyanate containing resin and the gas filled head space above the resin.

Such a substantially moisture-free atmosphere can be obtained or provided utilizing a number of methods, which will now be readily understood by the skilled artisan. For example, an inert gas blanket (e.g., nitrogen) on top of the open isocyanate bath could be used. Moreover, a dry air blanket on top of the open isocyanate bath could be used. Furthermore, a moisture absorbing device to prevent moisture from coming into contact and reacting with the isocyanate could be provided. Dry air blanketing is particularly preferred, for cost reasons.

Typically, the isocyanate bath is kept constant at about room temperature (about 25° C.); however, it may be desirable to modify the bath temperature. For example, some isocyanate formulations may have a relatively high viscosity and thus would pose a problem in obtaining complete wetting of the fibers. In such a case it may be desirable to heat the isocyanate bath to reduce the viscosity of the isocyanate bath, which will in turn increase wetting of the fibers by the isocyanate.

In any case, the fibers are supplied to the isocyanate material under conditions that prevent undesired reaction of the isocyanate material. The fibers are treated with the isocyanate material. Preferably, the fibers are treated so that they are substantially wetted by the isocyanate material. In other words, complete wetting may not be necessary, but is desirable. After treating the fibers the fibers are removed from the isocyanate material and treated with a suitable catalyst that will cause reaction of the isocyanate to form a polyurethane or polyurethane-polyisocyanurate material. Typically, reaction is caused by supplying heat to the treated fibers. Such heat is normally supplied by a die (or a plurality of dies) through which the fibers are pulled in a subsequent step.

In an alternative embodiment, the fibers may be treated with the catalyst before treating with the isocyanate-containing material. In such an embodiment, it is desirable to keep the catalyst in separate phase until the fibers are heated to cure the isocyanate-containing material. By “separate phase” it is meant that the catalyst remains on the surface of the fibers and does not dissolve and disperse in the bulk of the isocyanate containing material until the treated fibers enter the curing die. The mechanical action of the treated fibers moving through the die, and the heat of the die, then causes the latent catalyst on the surface of the fibers to become dissolved and dispersed throughout the bulk of the isocyanate containing material at the right time to promote cure.

In a preferred embodiment, treating of the fibers with a catalyst is accomplished by spraying the catalyst onto the fibers immediately after they are removed from the isocyanate bath. For example, a catalyst spraying gun, which are well known in the art, could be used to spray the catalyst onto the fibers. However, any suitable method of supplying the catalyst to the fibers may be used, so long as the catalyst remains at least partly separated from the isocyanate-containing material until curing is initiated, and it is supplied in a sufficient quantity to cause the isocyanate material to react to form the desired polyurethane or polyurethane-polyisocyanurate material. Again the mechanical action of the treated fibers entering the curing die and the heat of the die causes the catalyst sprayed on the surface of the isocyanate treated fibers to mix completely into the bulk of the isocyanate resin and promote cure. In this embodiment of the invention it is generally desirable that the catalyst is sprayed onto the isocyanate treated fibers shortly before the treated fibers enter the curing die, so that premature gelling does not occur.

The remaining steps of the process are those typically used in the known open bath pultrusion processes, e.g., heating, curing, pulling and cutting. For example, after treating the fibers with the isocyanate, the fibers could be passed through a gate and screw, which removes any excess isocyanate (the excess isocyanate could then be recycled back into the open bath for further use) and then treated with the catalyst. Moreover, after treating with the catalyst, the fibers are pulled through a heated die to cause reaction of the isocyanate and catalyst to form the polyurethane or polyurethane-polyisocyanurate material that will embed the fibers. Typically, the die temperature will be from about 150 to about 350° F. However, other die temperatures may be used.

After pulling the fibers through the heated die, the fiber-reinforced composite body can be cut to any suitable length by known methods.

A forming die may optionally be used ahead of the curing die, in order to pre-shape the treated fibers before entering the curing die. The forming die is preferably not used to promote cure. As such, the forming die is preferably cooler than the curing die and is most preferably near ambient temperature (about 25° C.). The optional forming die may contain cooling means to control the temperature of the forming die. The forming die, when used, is generally just ahead of the curing die and connected to the curing die.

It is preferred that the gel point of the isocyanate containing material occur inside the curing die, before the composite exits from the curing die. The isocyanate containing material should not gel before it enters the curing die.

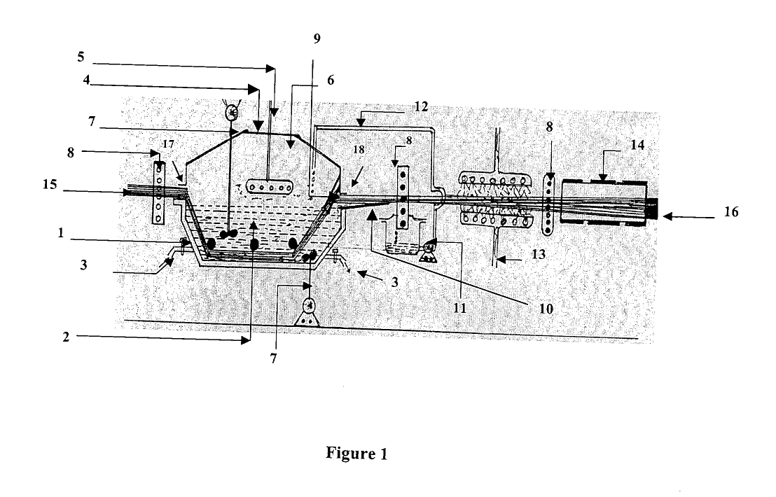

Turning now to FIG. 1, a preferred apparatus according to the invention is described. Vessel 1 for containing a suitable resin solution 2 is provided and may be for example a double jacket tank. The vessel 1 may optionally include a cooling/heating system 3, which may include an input and output section. Vessel 1 may optionally be provided with a cover 4 to help maintain the desired atmosphere over the resin solution 2. The apparatus is further provided with gas source line 5 to provide the desired gas blanket 6 over the resin solution 2. One or more optional mechanical stirrers 7 may be provided either above, below or both above and below the reinforcement material 15 located in resin solution 2. As can be seen in FIG. 1, the reinforcement material 15 enters vessel 1 at entrance point 17 and is treated with resin solution 2 in vessel 1 and exits vessel 1 at exit point 18. Prior to exit point 18 a means for removing excess resin 9 is provided in order to remove excess resin from the treated reinforcement 15 and return the excess resin to the resin solution bath 2. Moreover, an incline drip pan 10 may also be provided at or near exit point 18 to further help with the return of excess resin to resin solution bath 2. As can be seen, a plurality of guides 8 may be provided along the apparatus to help guide the reinforcement 15. In the preferred embodiment shown in FIG. 1, a first guide is provided prior to entrance point 17. A further guide is provided after the treated reinforcement 15 leaves the exit point 18 and this guide may further function to remove even further excess resin from the treated reinforcement 15 which excess resin may optionally be collected in drip pan 11 which is preferably provided with a cover. The excess resin may then be returned to vessel 1 utilizing, for example, pump and recirculation assembly 12. In any event, the treated reinforcement 15, after exiting exit point 18, is then treated with suitable catalyst using catalyst spray means 13. A further optional guide 8 may be provided after catalyst spray means 13 to help guide the reinforcement material 15 into pultrusion die 14. After passing through pultrusion die 14, a pultruded part 16 is obtained, which may be cut to any desirable length.

Any suitable isocyanate material can be used in the present invention. For example, aliphatic or aromatic diisocyanates may be used. Preferably, pure MDI, MDI variants, polymeric MDI, prepolymer MDI and blends may be used. More preferably, an MDI isocyanate composition comprising an isocyanate terminated prepolymer is used. Such materials typically have an NCO content of from about 6 to 33.5% by weight, a number averaged isocyanate (—NCO) group functionality of from about 2.0 to about 3.0, and a room temperature (25° C.) viscosity of from about 30 to about 3000 centipoise. Moreover, it may be desirable to use a combination of two or more isocyanate materials.

The isocyanate material should, preferably, have a viscosity capable of allowing for wetting of the fibers easily and quickly when the fibers are provided to (e.g., dipped into) the open bath of isocyanate material. Typically, a viscosity of from about 50 to 3000 centipoise at room temperature (25° C.) will allow for good wetting of the fiber material. Of course, higher viscosity isocyanate materials may also be used; however, higher viscosities may result in having to treat the fibers with the isocyanate material for longer periods of time to obtain sufficient wetting. A particularly preferred viscosity range is from about 100 cps to about 1000 cps at 25° C. The viscosity of the isocyanate containing material which is relevant is the viscosity at the time the material is used to impregnate the fibrous reinforcing material in the open bath.

As noted previously, the isocyanate containing material may optionally contain unreacted or partly reacted active hydrogen containing materials dissolved or dispersed therein; under the proviso that these do not cause premature gelling, fouling of the bath due to buildup of solids or gels, or interfere with the fiber impregnation process to a degree which makes attainment of the desired properties of the final composite impossible, under the range of processing conditions available on the processing equipment. When used at all, the preferred classes of unreacted or partly reacted active hydrogen compounds are polyols (aliphatic and/or aromatic), more preferably polyether and/or polyester polyols. The preferred polyols in this embodiment are polyether and/or polyester based nominal diols or triols having primary and/or secondary —OH groups bound to aliphatic carbon atoms. The hydroxyl equivalent weights of the preferred polyols are in the range of from about 50 to about 2000, more preferably 800 to about 1500, and still more preferably from about 900 to about 1200, on a number averaged basis. The polyols are preferably liquids at 40° C., are more preferably liquids also at 30° C. Nominal diols are generally preferred over nominal triols. Mixtures of high and low equivalent weight polyols made are used if desired in practicing this embodiment of the invention. The term “nominal”, used to describe the functionality of a polyol, is a term used in the art to denote the expected functionality of the polyol predicted from the raw materials used in its production. The actual functionality may sometimes differ from the nominal functionality. Usually these differences are not significant in the context of this invention.

A particularly preferred class of MDI based isocyanate containing materials suitable for use in the invention have the general formulation “Final MDI Formulation” below:

I) Base MDI Formulation:

Polymeric-MDI (number average NCO functionality 2.6 to 2.9; NCO content 31-32% by wt. of the polymeric MDI): 0 to 35% by wt., more preferably 5 to 25% by wt. of the total base MDI isocyanate formulation.

Polymeric MDI itself normally contains about 40 to 60% by weight of polymethylene polyphenyl polyisocyanate species of the MDI series having —NCO functionalities of 3 or higher. The remainder of the composition of polymeric MDI is 4,4′-MDI (about 30 to about 59% by weight), 2,4′-MDI (about 1 to about 5% by weight), and 2,2′-MDI (a trace to about 1% by weight).

4,4′-MDI (in addition to that present in the polymeric MDI): 30 to 90% by weight of the base MDI isocyanate, more preferably 40 to 85%.

2,4′-MDI (in addition to that present in the polymeric MDI): 0.2 to 30% of the base MDI isocyanate composition by weight, more preferably 1 to 20%.

2,2′-MDI (in addition to that present in the polymeric MDI): A trace to about 1% by wt.

Uretonimine Modified derivatives of MDI isocyanates: 0 to 5% by weight, more preferably 0.2 to about 3%, of the base MDI formulation.

This formulation of the base MDI isocyanate must total 100% by weight.

II) Final MDI Formulation:

Base MDI Formulation (above): 50 to 95% by weight, more preferably 70 to 90% by weight, and still more preferably 75 to 85% by weight of the final MDI formulation.

Polyols: 5 to 50% by weight, more preferably 10 to 30% by weight, and still more preferably 15 to 25% by weight of the final MDI formulation. These polyol weights are prior to the reaction of the polyols with the base MDI formulation to form prepolymers. One or more polyols may be used. The weight percent ranges noted above are for the total (combined) polyol weight.

This formulation of the final MDI composition must total 100% by weight.

In this preferred final MDI composition it is highly preferred that the polyols are fully reacted with the base isocyanate to form prepolymers. Therefore, the final composition contains isocyanate terminated urethane prepolymers in admixture with monomeric isocyanate species. The preferred final NCO content by weight of the final MDI formulation is between 20 and 30%, more preferably 21 to 27%, and the final functionality of —NCO groups is from 2.00 to about 2.5, more preferably 2.01 to 2.4, on a number averaged basis. The final composition is preferably a stable liquid at 25° C. and has a viscosity less than 1000 cps but greater than 100 cps at 25° C.

The preferred polyols used in the preparation of this preferred MDI composition are polyether and/or polyester based nominal diols or triols having primary and/or secondary —OH groups bound to aliphatic carbon atoms. The hydroxyl equivalent weights of the preferred polyols are in the range of from about 500 to about 2000, more preferably 800 to about 1500, and still more preferably from about 900 to about 1200, on a number averaged basis. The polyols are preferably liquids at 40° C., and more preferably liquids also at 30° C. Nominal diols are generally preferred over nominal triols.

The composites according to the invention contain at least one porous reinforcing structure. This structure preferably comprises a plurality of fibers. The porous reinforcing structures may for example be continuous fiber tows, mats, combinations of these, and the like.

Any suitable fibers may be used. However, the fibers should be long relative to the open impregnation bath (measured in the direction of fiber flow through said bath). More preferably, the fibers are at least twice as long as the bath. Still more preferably, the fibers are at least 10 times the length of the bath. Most preferably the fibers are continuous. Glass fibers are one preferred type of fiber material and the fibers may be used as, for example, rovings, tows, continuous strand mat, bi-directional rovings, unidirectional rovings and mats, bi-directional glass tapes, or any combination of these.

Additional preferred fibers include, for example, KEVLAR® fibers, carbon, boron, nylon, cloth, thermoplastic resin, artificial and natural fibers, and metal fibers, such as aluminum, iron, titanium, steel, etc. Natural fibers that may be used include jute, hemp, cotton, wool, silk, mixtures of these, and the like. Combinations of different fiber types may be used if desired.

The catalyst can be supplied in any suitable manner, but typically it is supplied in solution with a liquid solvent for ease of application. The solvent, in a preferred embodiment, is an isocyanate reactive material such as a glycol. In another preferred embodiment a non-volatile inert solvent (carrier) can be used, such as a hydrocarbon oil having a boiling point of greater than 150° C., preferably greater than 200° C., at 1 atmosphere pressure. However, it is possible to practice the invention without any solvent if the viscosity of the catalyst is low enough and the isocyanate compatibility of the (preferably liquid) catalyst is suitable. Various catalyst concentrations can be used, depending upon the desired results. Moreover, any suitable solvent can be used. However, it is desirable, when using a solvent, that the catalyst be capable of dissolving in the solvent and form a low viscous solution. In this regard, typical room temperature (25° C.) viscosity of the catalyst solution is in the range of from about 20 to about 500 centipoise. Preferably, the catalyst solution has a viscosity in the range of from about 50 to about 300 centipoise. More preferably, from about 80 to about 100 centipoise.

The catalyst may be solid, liquid or gaseous. Preferred catalyst compositions are liquid at 25° C. If the catalyst compound is not itself liquid, it is preferred to dissolve it in a liquid solvent, or a reactive liquid carrier, in order to provide a catalyst composition (including catalyst, plus solvent or carrier) that is liquid at 25° C. The catalyst may be organic, inorganic, organometallic, or metallic. Suitable organic catalysts include, for example, amine based or non-amine based catalysts which will trigger urethane and/or polyisocyanurate reactions, as desired. Suitable organometallic catalysts include, for example, tin, nickel, or other metal-based organic materials. Further examples of suitable catalysts include, for example, sodium, potassium, calcium, etc. based acid salts in organic media. Especially preferred are potassium carboxylates such as potassium 2-ethylhexanoate.

If the catalyst is a gas or is sufficiently volatile, it may be sprayed onto the treated fibers in gas form without a solvent or a carrier. However, unless the catalyst contains isocyanate reactive groups capable of binding it chemically into the final polymer, it is highly preferred to use catalyst species that are non-volatile. By non-volatile it is meant that the catalyst itself has a boiling point at 1 atmosphere pressure of greater than 150° C., preferably greater than 200° C., and more preferably greater than 250° C. Likewise, for safety and environmental reasons, it is preferred to use solvents that are non-volatile (as defined above) and/or solvents that contain isocyanate reactive groups.

In a preferred embodiment, the catalyst material is dissolved in a solvent and sprayed onto the fibers. The catalyst solution can be prepared in various concentrations. Preferably, the catalyst solution is prepared in an about 30 to 50 percent by weight concentration of catalyst. More preferably, the catalyst solution is prepared in an about 50 percent by weight concentration of catalyst. The catalyst may be sprayed onto isocyanate treated fibers; applied to non-isocyanate-treated fibers in a volatile solvent (e.g., water) and dried, followed by isocyanate treatment; or any combination thereof.

The viscosity of the catalyst solution should, preferably, be low enough such that it is capable of forming aerosols when the catalyst solution is to be sprayed onto the fibers. The catalyst should be relatively slow to dissolve in the isocyanate at bath temperature, particularly if the catalyst is pre applied to the fibers before the latter are treated with the isocyanate containing material. In any case, dissolution and cure will take place under the heat and pressure of the curing die.

If sprayed onto the isocyanate resin treated fibers, the catalyst should be applied rapidly enough to avoid pre-cure (i.e., curing of the isocyanate before the fibers enter the die). If the catalyst is pre-applied to the fibers (i.e., applied before the fibers are treated with isocyanate), the catalyst should be insoluble enough in the isocyanate at the bath temperature to avoid substantial pre-curing. Mixing and solubilization should take place in the die.

The amount of isocyanate reactive groups introduced via the catalyst stream is preferably small relative to the number of free isocyanate (—NCO) groups present in the isocyanate containing material. Preferably, the mole ratio of isocyanate reactive groups due to the catalyst composition is less than 20% of the free —NCO groups present, more preferably less than 15%, still more preferably less than 10%, even more preferably less than 5%, and most preferably 0 to less than 3%. The ratio of the catalyst stream to the isocyanate containing material need not be as precisely controlled, as is necessary in two component processing modes. This is a major advantage of the process according to the invention, which makes it possible to use open-bath equipment.

Particularly preferred catalysts are those capable of promoting both urethane and isocyanurate forming reactions, under the conditions of cure.

In accordance with the invention, at least one catalyst is applied to the isocyanate treated fibers (shortly before curing of the composite), and/or applied to the reinforcing fibers before the fibers are treated with isocyanate (in which case the catalyst should remain in a different phase until it enters the curing die). It is however within the scope of the invention to optionally also include one or more additional catalyst(s) in admixture with the isocyanate containing material itself. In this embodiment it is important that the additional catalyst(s) not cause premature gelling or excessive thickening of the isocyanate containing material. This may be accomplished, for example, by limiting the additional catalyst(s) to species which are heat activated, or by using some form of microencapsulation, or by keeping the level of the additional catalyst(s) very low, or some combination of these techniques. These optional embodiments will be appreciated by those skilled in the art.

An advantage of the process according to this invention is that standard catalysts may be used. It is not necessary to use specialized catalysts such as “delayed action” or “heat activated” catalysts known in the art, although these may optionally be used if desired. A non-limiting example of a preferred optional delayed action (heat activated) catalyst is nickel acetyl acetonate.

As stated above, suitable additives may be used. The additives are, typically, added to the isocyanate material. For example, fillers, internal mold release agents, fire retardants, etc. may be added to the isocyanate material. In an alternative embodiment, the additives may be provided to the fibers, such as by coating the fibers with the additive.

Suitable fillers can include, for example, calcium carbonate, barium sulfate, clay, aluminum trihydrate, antimony oxide, milled glass fibers, wollastonite, talc, mica, etc.

Further, suitable internal mold release agents may include, for example, amides such as erucamide or stearamide, fatty acids such as oleic acid, oleic acid amides, fatty esters such as LOXIOL® G71S fatty ester (from Henkel), carnuba wax, beeswax (natural esters), butyl stearate, octyl stearate, ethylene glycol monostearate, ethylene glycol distearate, glycerin mono-oleate, glycerin di-oleate, and glycerin tri-oleate; and esters of polycarboxylic acids with long chain aliphatic monovalent alcohols such as dioctyl sebacate, mixtures of (a) mixed esters of aliphatic polyols, dicarboxylic acids and long-chained aliphatic monocarboxylic acids, and (b) esters of the groups: (1) esters of dicarboxylic acids and long-chained aliphatic monofunctional alcohols, (2) esters of long-chained aliphatic monofunctional alcohols and long-chained aliphatic monofunctional carboxylic acids, (3) complete or partial esters of aliphatic polyols and long-chained aliphatic monocarboxylic acids, silicones such as TEGOSTAB® L1-421T silicon (from Goldschmidt); KEMESTER® 5721 fatty acid (from Witco Corporation), metal carboxylates such as zinc stearate and calcium stearate, waxes such as montan wax and chlorinated waxes, fluorine containing compounds such as polytetrafluoroethylene; alkyl phosphates (both acidic and non-acidic types such as Zelec UN, Zelec AN, Zelec MR, Zelec VM, Zelec UN, Zelac LA-1; which are all commercially available from Stepan Chemical Company), chlorinated-alkyl phosphates, and hydrocarbon oils.

In an aspect of the invention, the only reactive species present in the isocyanate containing material are isocyanate (—NCO) groups. In this embodiment the catalyst, or catalyst combination, must be capable of promoting the trimerization of isocyanate groups to form isocyanurate groups during the curing process in the curing die. However, if the isocyanate containing composition also contains unreacted groups (such as alcohol groups) that react with isocyanate to form urethane linkages, then the ratio of these isocyanate reactive groups to free isocyanate (—NCO) groups must be considered. The ratio of the number of —NCO groups to the number of isocyanate reactive groups (mole ratio) is called the Index, and is typically expressed as a percent (i.e. multiplied by 100). In the embodiment wherein the isocyanate containing material contains only —NCO groups, as the reactive species present, then the Index is technically infinite and does not apply. However, if the Index of the isocyanate containing material is greater than 150%, then the catalyst package should contain a species capable of promoting the trimerization of isocyanate groups to form isocyanurate groups under the conditions of curing. If the Index is 150 or less, then a trimerization catalyst is not essential. In this eventuality, and when the isocyanate reactive material present is a polyol, at least one catalyst capable of promoting the urethane reaction should be employed. The Index should be at least 80%, and preferably greater than 90%.

The method of the invention can be extended to other types of reinforced thermoset composites. For example, glass mats may be impregnated with an isocyanate containing material, such as one comprising MDI or prepolymers thereof. An isocyanurate catalyst may be sprayed onto the resulting prepreg (or, alternatively, coated onto the fibers), and then the prepreg may be cured and shaped in a hot mold to form the composite. This is a new approach to sheet molding compounds (SMC), and the like.

The application of this invention can be further extended to resin transfer molding (RTM) and its related processes such as vacuum assisted RTM (VRTM), etc. In such processes the precut reinforcement is sprayed or coated with a catalyst (urethane or trimerization catalyst) and then placed in the hot mold adjusted to desired temperature. Then the mold is closed and the isocyanate containing material, such as one comprising MDI or prepolymers, is injected to fill the mold, which is then cured and shaped to form the composite. An optional heat-activated co-catalyst can be added to the resin material to enhance the cure process.

Also, the process can be used in filament winding technology. Here the reinforcement, usually in the form of a filament, is dipped in an isocyanate bath similar to the one described for the pultrusion process. The isocyanate wet filament is then wound on a circular or non-circular mandrel to a specific thickness. Care should be taken such that the isocyanate reinforced woven mandrel is kept free from moisture. After every fixed number of rotations, the isocyanate reinforced woven mandrel is sprayed with a catalyst solution. On finishing the winding process, the mandrel is then placed in an oven for curing. For example, the filament wound part may be kept in an oven from several hours to days to cure. By using this technology the cure time can be reduced drastically with inherited niche properties such as high impact strength, flame and chemical resistance, microbial and hydrolysis resistant. Besides spraying of the catalyst on to the wound filament, it is also possible to use catalyst coated reinforcement where the catalyst is isocyanate insoluble at bath temperature in this process. Such a process can be used in making composite pipes for gas or oil transportation and also in other areas where circular or non-circular architecture is required for structural or other applications. This process can be faster, more efficient and can have better physical properties than the conventional resin systems used in filament winding process.

Also, the current process can be used in a wet layup process for making composites. In such a process the reinforcement is dipped in an isocyanate bath. The isocyanate impregnated sheet(s) are then placed inside a hot mold adjusted to a fixed temperature. This is then followed by spraying the catalyst solution on the surface of isocyanate impregnated reinforcement. In certain instances the catalyst solution can be mixed with a mold release agent or an internal mold release agent to assist release of cured product. In another instance, the fiber sheet can be pre-coated with a catalyst and then dipped in the isocyanate. In yet another instance an optional insoluble temperature sensitive catalyst may be dispersed in the isocyanate at the bath temperature, and the resulting isocyanate resin then used to treat the fibrous reinforcing structure. After the application of catalyst onto the impregnated reinforcement the mold is closed, and sufficient pressure is applied for a sufficient amount of time. Then the mold lid is opened and the cured part can be removed.

The method of the invention may optionally be used in resin transfer molding, provided that the catalyst which is applied to the isocyanate treated prepreg, and/or applied to the fibers before the isocyanate treatment thereof, can be adequately mixed and dispersed into the bulk of the resin during the curing process.

Pultrusion is a particularly preferred process for the application of this invention, because the curing die provides a combination of mechanical and thermal energy suitable for dissolving and dispersing the catalyst into the bulk of the isocyanate containing material on the fibers, at just the right time to promote cure. The broader applications of the invention, noted above, will benefit from the use of a curing apparatus that provides for a similar combination of mechanical and thermal energy in order to homogeneously disperse the catalyst into the bulk of the resin on the impregnated fibrous reinforcing material during cure. Such a curing apparatus may include, for example, a heated press.

In this description of the invention, and in the Examples which follow, it is to be understood that all molecular weights, equivalent weights, and functionalities of polymeric materials are number averaged unless otherwise indicated. Likewise, all molecular weights, equivalent weights, and functionalities of pure compounds are absolute, unless otherwise stated.

### EXAMPLES

Glossary: In the following examples, the following names and abbreviations are understood to have the meanings defined below:

1. MDI is diphenylmethane diisocyanate.

2. HMDI is hexamethylene diisocyanate.

3. TMXDI is tetramethyl xylene diisocyanate.

4. TDI is toluene diisocyanate.

5. IPDI is isophorone diisocyanate.

6. PPDI is para phenyl diisocyanate.

7. PUR is polyurethane.

8. HQEE is hydroquinone bis-(2-hydroxyethyl) ether from Aldrich Chemicals.

9. TMP is trimethylol propane.

10. DPG is dipropylene glycol.

11. RUBINATE® 7304 isocyanate is a polymeric MDI having an NCO value of about 30.7 from Huntsman Polyurethanes.

12. RUBINATE® 8700 isocyanate is a polymeric MDI having MCO value of about 31.5 from Huntsman Polyurethanes.

13. SUPRASEC® 2544 prepolymer is a prepolymer MDI having NCO value of about 18.9 from Huntsman Polyurethanes.

14. SUPRASEC® 2981 prepolymer is a prepolymer MDI having NCO value of about 18.6 from Huntsman Polyurethanes.

15. SUPRASEC® 2000 prepolymer is a prepolymer MDI having NCO value of about 17.0 from Huntsman Polyurethanes.

16. SUPRASEC® 2433 prepolymer is a prepolymer MDI having NCO value of about 19.0 from Huntsman Polyurethanes.

17. JEFFOL® PPG 2000 polyol is a glycerol based polypropylene oxide polyether polyol having a functionality of 2 and a hydroxyl value of 56 mg KOH/gm from Huntsman Polyurethanes.

18. JEFFOL® G 30-650 polyol is a glycerol based polyether polyol having a functionality of 3 and a hydroxyl value of 650 mg KOH/gm from Huntsman Polyurethanes.

19. JEFFOL® PPG 400 polyol is a glycerol based polypropylene oxide polyether polyol having a functionality of 2 and a hydroxyl value of 255 mg KOH/gm from Huntsman Polyurethanes.

20. STEPANPOL® PS 20-200A polyol is diethylene glycol/orthophthalate polyester polyol having a functionality of 2 and a hydroxyl value of 195 mg KOH/gm from Stepan Corporation.

21. Axel INT PS 125 is an internal mold release agent for polyurethane rigid foams from Axel.

22. LOXIOL® G71S ester is a complex unsaturated blend of oleic and linoleic acid esters from Henkel Corporation, Kankakee, Ill.

23. Munch/INT/20A is a fatty acid ester derivative internal mold release agent from Munch Co, Germany.

24. KEMESTER® 5721 tridecyl stearate from Witco Corporation, Greenwich, Conn. is tridecyl stearate.

25. DABCO® K-15 catalyst is potassium carboxylate salt-based catalyst from Air Products and Chemicals, Allentown, Pa.

26. DABCO® T-45 catalyst is a potassium carboxylate salt catalyst from Air Products and Chemicals, Allentown, Pa.

27. DABCO® TMR catalyst is 2-Ethyl hexanoic salt of N.N-dimethyl isopropanolamine in dipropylene glycol (approximately 70%) from Air Products and Chemicals, Allentown, Pa.

28. DABCO® T-12 catalyst is 100% dibutyltin dilaurate from Air Products and Chemicals, Allentown, Pa.

29. POLYCAT® 42 catalyst mixture of potassium 2-ethyl hexaoate, partial 2-ethyl hexaic salt of N,N′N″-tris (dimethyl aminopropyl) hexahydro triazine from Air Products and Chemicals, Allentown, Pa.

30. POLYCAT® 46 catalyst is 38% potassium acetate in ethylene glycol Air Products and Chemicals, Allentown, Pa.

31. Curathane 52 is mixed sodium/ammonium salt of a carboxylic acid in a mixture of diethylene glycol and nonyl phenol Air Products and Chemicals, Allentown, Pa.

32. NIAX® LC-5615 nickel acetylacetonate is nickel acetylacetonate from OSI Specialties.

33. PIR is polyisocyanurate.

34. Polymeric MDI is a mixture of MDI with higher functionality (i.e. isocyanate group functionality higher than 2) polymethylene polyphenyl polyisocyanate species.

35. Montan Wax LHT 1 is an external mold release product, available from Chem Trend, Howell, Mich.

The following non-limiting Examples are provided to further illustrate the invention and should not be construed to limit the invention.

### Example 1

This example illustrates pultrusion of a glass fiber reinforced one component open bath polyisocyanurate system. The reactive components in the open bath are shown below.

| Reactive Components | Amount (%) |
|---|---|
| RUBINATE ® 7304 isocyanate | 44.640 |
| SUPRASEC ® 2544 prepolymer | 44.640 |
| Motor Oil 10W30 | 05.360 |
| LOXIOL ® G71S ester | 05.360 |
| Total | 100.00 |

The reaction mixture was kept at room temperature (25° C.) during the trial. The reinforcement in form of tapes and rovings (five plies of bi-directional glass mat referred to as tapes with six tows of glass rovings) was dipped through the reaction mixture. The wet reinforcement was then passed through a series of gates to remove the excess of impregnated reaction mixture. This excess reaction solution can be recycled back to the tank provided it is collected under inert conditions (i.e. free from moisture).

Utilizing an airless spray gun (Wagner 1800 PSI 2 Step Pro Duty Power Painter), approximately 15-20 inches before the heating die DABCO® K-15 catalyst solution was sprayed at a rate of about 0.1 to 0.15 grams of solution per second on to the top and bottom of the reinforcement for a period of five to seven seconds (DABCO® K-15 catalyst is a commercially available metal based isocyanurate catalyst from Air Products and Chemicals, Allentown, Pa.). The as received catalyst is a highly viscous solution (viscosity 7200 centipoise at 27° C.) and is made by dissolving potassium 2-ethylhexanoate in diethylene glycol. The exact composition of DABCO® K-15 catalyst is proprietary and not publicly available. This catalyst was further diluted using a 1:1 (wt/wt) mixture of motor oil (Mobil oil 10W30) and LOXIOL® G71S ester. Thirty parts by weight of the DABCO® K-15 catalyst was diluted with 70 parts by weight of the oil and LOXIOL® G71S mixture. This results in a 30% DABCO® K-15 catalyst solution which was used to spray the isocyanate impregnated reinforcement.

The catalyst treated wet reinforcement was then allowed to pass through a series of gates which helped to squeeze the catalyst into the bulk of the reinforcement and also to remove the excess of reaction mixture before it entered the forming die.

The temperature of the curing die connected via the forming die was in the range of 190-200° F. No cooling coil system was connected to the die during this study. The pull speed of 10 inches/minute was kept constant during this run. The initial pull strength (i.e. the pulling force, required to pull the bare fibers through the die) without the resin in the curing die was in the range of 110-125 pounds. As the fibers entered the die and began being pultruded, this force (pull strength) went up into the range of 400-425 pounds and remained more or less constant at this pull strength. More than 15 meters of glass fiber reinforced polyisocyanurate was pultruded. The pultruded plank was found to be fully cured and showed no signs of wet spots with a smooth and shiny surface.

### Example 2

This example further illustrates pultrusion of a glass fiber reinforced one component open bath polyisocyanurate system. The reactive components in the open bath are shown below.

| Reactive Components | Amount (%) |
|---|---|
| RUBINATE ® 7304 isocyanate | 44.645 |
| SUPRASEC ® 2544 prepolymer | 44.645 |
| Motor Oil 10W30 | 03.570 |
| LOXIOL ® G71S ester | 03.570 |
| Munch/INT/20A | 03.570 |
| Total | 100.00 |

The above components were prepared as in Example 1 to form an open bath. The temperature of chemical mixture, glass geometry and pull speed was kept constant as in Example 1. In this Example, the catalyst concentration was reduced to half as compared to Example 1. 15 parts by weight of DABCO® K-15 catalyst was dissolved in 85 parts by weight of a KEMESTER® 5721 tridecyl stearate-motor oil-LOXIOL® G71S ester (0.5:1:1 wt ratio) mixture. This resulted in a 15% catalyst solution and was used for spraying onto the resin impregnated glass reinforcement. Using the airless spray gun described in Example 1, the catalyst solution was sprayed at a rate of about 0.1-0.15 grams of solution per second. The temperature of the curing die connected via the forming die was in the range of 210-220° F. A cooling coil system was connected to the forming die. The initial pull strength without the resin in the curing die was in the range of 110-125 pounds. As the treated material was being pultruded it went up into the range of 400-450 pounds and remained steady during the remainder of the process. 15 meters of composite was pultruded. The pultruded plank was found to be fully cured and showed no signs of wet spots with a smooth and shiny surface.

### Example 3

This example further illustrates pultrusion of a glass fiber reinforced one component open bath polyisocyanurate system. The reactive components in the open bath are shown below.

| Reactive Components | Amount (%) |
|---|---|
| RUBINATE ® 7304 isocyanate | 44.645 |
| SUPRASEC ® 2544 prepolymer | 44.645 |
| Motor Oil 10W30 | 04.460 |
| LOXIOL ® G71S ester | 04.460 |
| KEMESTER ® 5721 tridecyl stearate | 01.790 |
| Total | 100.00 |

In this Example, the catalyst concentration was reduced to 10%. 10 parts by weight of DABCO® K-15 catalyst was dissolved in 90 parts by weight of a Munch/INT/20A -motor oil (1:1 wt ratio) mixture. This resulted in a 10% catalyst solution and was used for spraying onto the resin impregnated glass reinforcement. Using the airless spray gun described in Example 1, the catalyst solution was sprayed at a rate of about 0.1-0.15 grams of solution per second. The temperature of curing die connected via the forming die was in the range of 260-270° F. A cooling coil system was connected to the forming die. The initial pull strength without the resin in the curing die was in the range of 110-125 pounds. As the treated material was being pultruded it went up into the range of 400-450 pounds and remained steady during the remainder of the process. More than 25 meters of fully cured plank with no signs of wet spots on the surface was obtained.

### Example 4

This example further illustrates pultrusion of a glass fiber reinforced one component open bath polyisocyanurate system. The reactive components in the open bath are shown below.

| Reactive Components | Amount (%) |
|---|---|
| RUBINATE ® 7304 isocyanate | 47.170 |
| SUPRASEC ® 2544 prepolymer | 47.170 |
| Munch/INT/20A | 04.720 |
| KEMESTER ® 5721 tridecyl stearate | 00.940 |
| Total | 100.00 |

In this Example, the catalyst concentration was 10%. It was prepared by dissolving 10 parts by weight of DABCO K-15 catalyst in 90 parts by weight of a Munch/INT/20A-motor oil-LOXIOL® G715 ester (0.5:1:1 wt ratio) mixture. This 10% catalyst solution was then used for spraying onto the isocyanate impregnated glass reinforcement. Using the airless spray gun described in Example 1, the catalyst solution was sprayed at a rate of about 0.1-0.15 grams of solution per second. The curing die temperature was in the range of 215-225° F. More than five meters of sample was pultruded.

### Example 5

This example further illustrates pultrusion of a glass fiber reinforced one component open bath polyisocyanurate system. The reactive components in the open bath are shown below.

| Reactive Components | Amount (%) |
|---|---|
| RUBINATE ® 7304 isocyanate | 47.170 |
| SUPRASEC ® 2544 prepolymer | 47.170 |
| Munch/INT/20A | 04.720 |
| KEMESTER ® 5721 tridecyl stearate | 00.940 |
| Total | 100.00 |

In this Example, the catalyst concentration was maintained at 10%. It was prepared by dissolving 10 parts by weight of DABCO® K-15 catalyst in 90 parts by weight of a KEMESTER® 5721 tridecyl stearate-Munch/INT/20A (1:1 wt ratio) mixture. The resulting 10% DABCO® K-15 catalyst solution was then used for spraying onto the isocyanate impregnated glass reinforcement. Using the airless spray gun described in Example 1, the catalyst solution was sprayed at a rate of about 0.1-0.5 grams of solution per second. The curing die temperature was in the range of 200-210° F. More than four meters of sample was pultruded.

Laboratory scale procedure to verify the concept of a general open bath composite making process.

Two clean steel plates were placed on a hot plate for heating adjusted at 275±5° F. (135±5° C.). After the plates reached the desired temperature, they were coated with a thin layer of mold release (Montan wax LHT 1).

An isocyanate bath was prepared by mixing two different isocyanates (MDI prepolymer and polymeric MDI) in a shallow glass trough that could be covered with a flat lid with an opening at the top. This mimics the resin bath in a typical pultrusion set-up. The formulations used during this study are described in Examples 6-13. A dry nitrogen blanket was pumped in the trough to create a nitrogen blanket on the isocyanate bath so as to prevent undesired moisture reaction.

In a typical experiment the catalyst mixture was made as follows. DABCO® K 45 catalyst or DABCO® K-15 catalyst was used as received. It was further diluted in a blend of LOXIOL® G71S ester and motor oil (Mobil 10W 30) (1:1 wt/wt ratio). For example, a 30% solution of catalyst was made using the LOXIOL® G71S ester-motor oil mixture (30 pbw of DABCO® T-45 catalyst and 70 pbw of the oil-LOXIOL® G71S ester mixture). This was one formulation used as a spraying solution in these examples.

A 4×4 square inch random-fiber glass mat was used during this experiment. The edge of the glass mat was held with the help of a pair of tweezers and was dipped in the formulation bath in Examples 6-13. The dipping was done for 3-4 seconds. The resin treated mat was lightly squeezed between two metal plates (approximate pressure of 1-2 psi) so as to remove the excess of isocyanate containing material from the surfaces of the treated mat. This was done to mimic the resin squeezing process in a typical open bath pultrusion line. Then the reinforcement was again held with a pair of tweezers on the edge, and was sprayed with a catalyst solution for 2-3 seconds on both sides of the reinforcement. This was immediately followed by placing the treated reinforcement in-between the two hot plates adjusted to the desired temperature. A slight pressure was applied on the hot plates (approximately 10-15 psi) with the help of standard laboratory clamps so as to mimic the internal pressure of a pultrusion die. The plates were held tightly for 10-15 seconds and then followed by releasing of the clamped pressure to remove cured composite.

The following was noted during this study: Several layers of random glass mats were used (1-12 plies) and could be cured comfortably without sticking to the hot steel plates. As shown in the following examples, this experimental procedure was repeated with various types of isocyanate mixtures and with different types of non-reactive additives and fillers and every time it was possible to make cured composites with no signs of wet spots or sticking to the metal plates.

### Example 6

| Reactive Components | Amount (%) |
|---|---|
| RUBINATE ® 7304 isocyanate | 44.640 |
| SUPRASEC ® 2981 prepolymer | 44.640 |
| Motor Oil 10W30 | 05.360 |
| LOXIOL ® G71S ester | 05.360 |
| Total | 100.00 |

Catalyst solution: 15 pbw of DABCO® T-45 catalyst in 85 pbw of KEMESTER® 5721 tridecyl stearate-Munch/INT/20A mixture (1:1 wt ratio) was applied to both sides of the glass mat. Using the airless spray gun described in Example 1, the catalyst solution was sprayed at a rate of about 0.1-0.15 grams of solution per second. One to 15 plies of continuous strand mat (4×4 square inch) was used during this study.

Using the same Reactive Components shown above, 15 pbw of DABCO® K-15 catalyst in 85 pbw of the motor oil-LOXIOL® G71S ester (1:1 wt ratio) mixture was applied to both sides of the glass mat. The catalyst solution was applied as described above. One to 15 plies of continuous strand mat (4×4 square inch) was used during this study.

Similarly, using the same Reactive Components shown above, 10 pbw of DABCO® T-45 catalyst plus 5 pbw of DABCO® TMR catalyst in 85 pbw of a motor oil-LOXIOL® G71S ester (1:1 wt ratio) mixture was applied to both sides of the glass mat. The catalyst solution was applied as described above. One to 15 plies of continuous strand mat (4×4 square inch) were used during this study.

### Example 7

| Reactive Components | Amount (%) |
|---|---|
| RUBINATE ® 7304 isocyanate | 44.640 |
| SUPRASEC ® 2433 prepolymer | 44.640 |
| Motor Oil 10W30 | 05.360 |
| LOXIOL ® G71S ester | 05.360 |
| Total | 100.00 |

Catalyst solution: 15 pbw of DABCO® T-45 catalyst in 85 pbw of a KEMESTER® 5721 tridecyl stearate-Munch/INT/20A mixture (1:1 wt ratio) was applied to both sides of the glass mat, as described above in Example 6. One to 15 plies of continuous strand mat (4×4 square inch) were used during this study.

Using the same Reactive Components shown above, 15 pbw of DABCO® K-15 catalyst in 85 pbw of a motor oil-LOXIOL® G71S ester (1:1 wt ratio) mixture was applied to both sides of the mat, as described above. One to 15 plies of continuous strand mat (4×4 square inch) were used during this study.

Similarly, using the same Reactive Components shown above, 10 pbw of DABCO® T-45 catalyst plus 5 pbw of DABCO TMR catalyst in 85 pbw of the motor oil-LOXIOL® G71S ester (1:1 wt ratio) mixture was applied to both sides of the mat, as described above. One to 15 plies of continuous strand mat (4×4 square inch) were used during this study.

### Example 8

| Reactive Components | Amount (%) |
|---|---|
| RUBINATE ® 7304 isocyanate | 44.640 |
| SUPRASEC ® 2000 prepolymer | 44.640 |
| Motor Oil 10W30 | 05.360 |
| LOXIOL ® G71S ester | 05.360 |
| Total | 100.00 |

Catalyst solution: 15 pbw of a DABCO® T-45 catalyst in 85 pbw of a KEMESTER® 5721 tridecyl stearate-Munch/INT/20A mixture (1:1 wt ratio) was applied to both sides of the glass mat, as described above in Example 6. One to 15 plies of continuous strand mat (4×4 square inch) were used during this study.

Using the same Reactive Components shown above, 15 pbw of DABCO® K-15 catalyst in 85 pbw of the motor oil-LOXIOL® G71S ester (1:1 wt ratio) mixture was applied to both sides of the glass mat, as described above. One to 15 plies of continuous strand mat (4×4 square inch) were used during this study.

Similarly, using the same Reaction Components shown above, 10 pbw of DABCO® T-45 catalyst plus 5 pbw of DABCO® TMR catalyst in 85 pbw of motor oil-LOXIOL® G71S ester (1:1 wt ratio) mixture was used to verify the concept of one component pultrusion. One to 15 plies of continuous strand mat (4×4 square inch) was used during this study.

### Example 9

| Reactive Components | Amount (%) |
|---|---|
| RUBINATE ® 8700 isocyanate | 44.640 |
| SUPRASEC ® 2981 prepolymer | 44.640 |
| Motor Oil 10W30 | 05.360 |
| LOXIOL ® G71S ester | 05.360 |
| Total | 100.00 |

Catalyst solution: 15 pbw of a DABCO® T-45 catalyst in 85 pbw of KEMESTER® 5721 tridecyl stearate-Munch/INT/20A mixture (1:1 wt ratio) was applied to both sides of the glass mat at a rate of about 0.3-0.35 grams of solution per second, utilizing an air spray gun (Type Vol./2 Air Spray Gun from Schutze Spritzetechnik, Bremen, Germany). One to 15 plies of continuous strand mat (4×4 square inch) was used during this study.

Using the same Reactive Components shown above, 15 pbw of DABCO® K-15 catalyst in 85 pbw of motor oil-LOXIOL® G71S ester (1:1 wt ratio) mixture was applied to both sides of the glass mat, as described above. One to 15 plies of continuous strand mat (4×4 square inch) were used during this study.

Similarly, using the same Reactive Components shown above, 10 pbw of DABCO® T-45 catalyst plus 5 pbw of DABCO® TMR catalyst in 85 pbw of motor oil-LOXIOL® G71S ester (1:1 wt ratio) mixture was applied to both sides of the glass mat, as described above. One to 15 plies of continuous strand mat (4×4 square inch) were used during this study.

### Example 10

| Reactive Components | Amount (%) |
|---|---|
| RUBINATE ® 8700 isocyanate | 44.640 |
| SUPRASEC ® 2433 prepolymer | 44.640 |
| Motor Oil 10W30 | 05.360 |
| LOXIOL ® G71S ester | 05.360 |
| Total | 100.00 |

Catalyst solution: 15 pbw of DABCO® T-45 catalyst in 85 pbw of KEMESTER® tridecyl stearate-Munch/INT/20A mixture (1:1 wt ratio) was applied to both sides of the mat, as described in Example 9. One to 15 plies of continuous strand mat (4×4 square inch) were used during this study.

Using the same Reactive Components shown above, 15 pbw of DABCO® K-15 catalyst in 85 pbw of motor oil-LOXIOL® G71S ester (1:1 wt ratio) mixture was applied to both sides of the mat, as described above. One to 15 plies of continuous strand mat (4×4 square inch) were used during this study.

Similarly, using the same Reactive Components shown above, 10 pbw of DABCO® T-45 catalyst plus 5 pbw of DABCO® TMR catalyst in 85 pbw of the motor oil-LOXIOL® G71S ester (1:1 wt ratio) mixture was applied to both sides of the mat, as described above. One to 15 plies of continuous strand mat (4×4 square inch) were used during this study.

### Example 11

| Reactive Components | Amount (%) |
|---|---|
| RUBINATE ® 8700 isocyanate | 44.640 |
| SUPRASEC ® 2000 prepolymer | 44.640 |
| Motor Oil 10W30 | 05.360 |
| LOXIOL ® G71S ester | 05.360 |
| Total | 100.00 |

Catalyst solution: 15 pbw of DABCO® T-45 catalyst in 85 pbw of KEMESTER® 5721 tridecyl stearate-Munch/INT/20A mixture (1:1 wt ratio) was applied to both sides of the mat, as described in Example 9. One to 15 plies of continuous strand mat (4×4 square inch) were used during this study.

Using the same Reactive Components shown above, 15 pbw of DABCO® K-15 catalyst in 85 pbw of motor oil-LOXIOL® G71S ester (1:1 wt ratio) mixture was applied to both sides of the mat, as described above. One to 15 plies of continuous strand mat (4×4 square inch) were used during this study.

Similarly, using the same Reactive Components shown above, 10 pbw of DABCO® T-45 catalyst plus 5 pbw of DABCO® TMR catalyst in 85 pbw of motor oil-LOXIOL® G71S ester (1:1 wt ratio) mixture was applied to both sides of the mat, as described above. One to 15 plies of continuous strand mat (4×4 square inch) were used during this study.

### Example 12

| Reactive Components | Amount (%) |
|---|---|
| RUBINATE ® 7304 isocyanate | 43.640 |
| SUPRASEC ® 2000 prepolymer | 43.640 |
| NIAX ® LC 5615 nickel acetylacetonate | 02.000 |
| Motor Oil 10W30 | 05.360 |
| LOXIOL ® G71S ester | 05.360 |
| Total | 100.00 |

Catalyst solution: 15 pbw of DABCO® T-45 catalyst in 85 pbw of KEMESTER® 5721 tridecyl stearate-Munch/INT/20A mixture (1:1 wt ratio) was applied to both sides of the glass mat, as described in Example 9. One to 15 plies of continuous strand mat (4×4 square inch) were used during this study.

Using the same Reactive Components shown above, 15 pbw of DABCO® K-15 catalyst in 85 pbw of motor oil-LOXIOL® G71S ester (1:1 wt ratio) mixture was applied to both sides of the glass mat, as described above. One to 15 plies of continuous strand mat (4×4 square inch) were used during this study.

Similarly, using the same Reactive Components shown above, 10 pbw of DABCO® T-45 catalyst plus 5 pbw of DABCO® TMR catalyst in 85 pbw of motor oil-LOXIOL® G71S ester (1:1 wt ratio) mixture was applied to both sides of the glass mat, as described above. One to 15 plies of continuous strand mat (4×4 square inch) were used during this study.

### Example 13

| Reactive Components | Amount (%) |
|---|---|
| RUBINATE ® 8700 isocyanate | 43.640 |
| SUPRASEC ® 2000 prepolymer | 43.640 |
| NIAX ® LC 5615 nickel acetylacetonate | 02.000 |
| Motor Oil 10W30 | 05.360 |
| LOXIOL ® G71S ester | 05.360 |
| Total | 100.00 |

Catalyst solution: 15 pbw of DABCO® T-45 catalyst in 85 pbw of KEMESTER® 5721 tridecyl stearate-Munch/INT/20A mixture (1:1 wt ratio) was applied to both sides of the glass mat, as described in Example 9. One to 15 plies of continuous strand mat (4×4 square inch) were used during this study.

Using the same Reactive Components shown above, 15 pbw of DABCO® K-15 catalyst in 85 pbw of motor oil-LOXIOL® G71S ester (1:1 wt ratio) mixture was applied to both sides of the glass mat, as described above. One to 15 plies of continuous strand mat (4×4 square inch) were used during this study.

Similarly, using the same Reactive Components shown above, 10 pbw of DABCO® T-45 catalyst plus 5 pbw of DABCO® TMR catalyst in 85 pbw of motor oil-LOXIOL® G71S ester (1:1 wt ratio) mixture was applied to both sides of the glass mat, as described above. One to 15 plies of continuous strand mat (4×4 square inch) were used during this study.

Long gel time two component open bath process

Examples 14, 15 and 16 below are laboratory scale examples according to one aspect of the invention.

The examples demonstrate two component PUR systems which have a long gel time ranging from more than 30 minutes to several hours which can be placed, while still liquid and flowable, into a temperature controlled open bath for use in a one-component pultrusion processing mode. The bath size can be adjusted such that the material (reaction mixture) added to the bath is continuously replenished before the reaction mixture reaches its gel time.

### Example 14

| B-Components | Amount (%) |
|---|---|
| JEFFOL ® PPG 20001 polyol | 76.34 |
| HQEE | 15.27 |
| NIAX ® LC 5615 nickel acetylacetonate | 0.76 |
| LOXIOL ® G71-S ester | 5.73 |
| PE Powder AC 1702 | 1.90 |
| Total | 100.0 |

SUPRASEC® 2455 prepolymer [A-component].

Reaction run at 110 Index

The “A and “B” components are mixed to form a reaction mixture which is then fed to the open bath. This reaction mixture, when allowed to stay at room temperature, does not cure even after 6 hours (still liquid, but when placed on a hot plate cured rapidly). It becomes more viscous after 22 hours but is still usable. When the sample is sprayed with a trimerization catalyst it gels inside the hot plate and is removed as a fully cured polymer. This reaction can also be run with some of the other known polymeric isocyanates with high 2,4′-MDI content and also with some prepolymer containing isocyanates with NCO % ranging from 18-22%.

### Example 15

| B-Components | Amount (%) |
|---|---|
| JEFFOL ® PPG 2000 polyol | 82.0 |
| Trimethylol Propane (TMP) | 8.26 |
| Zinc Stearate | 1.50 |
| LOXIOL ® G71-S ester | 6.18 |
| PE Powder AC 1702 | 2.06 |
| Total | 100.0 |

SUPRASEC® 2544 prepolymer, as A-component.

Reaction run at 110 Index.

After 4 hours the reaction mixture was still liquid, but when placed on a hotplate with slight mixing it cured quickly.

### Example 16

| B-Components | Amount (%) |
|---|---|
| JEFFOL ® G 30-650 polyol | 36.17 |
| JEFFOL ® PPG 400 polyol | 9.60 |
| STEPANPOL ® PS 20-200A polyol | 20.55 |
| Oil LOXIOL ® G71S | 6.64 |
| Axel INT PS 125 | 0.35 |
| Kenreact KR 238S | 0.94 |
| Molecular Sieve | 4.28 |
| Calcium Carbonate | 21.20 |
| DABCO ® T-45 catalyst | 0.27 |
| Total | 100 |

Isocyanate used as A-component: RUBINATE® 7304 isocyanate (RUBINATE® M isocyanate may also be used), mixed with B-Components at an Index of 142. The gel time at room temperature was noted to be in between 28-30 minutes.

### Example 17

| B-Components | Amount (%) |
|---|---|
| JEFFOL ® G 30-650 polyol | 80.80 |
| Dipropylene Glycol (DPG) | 11.52 |
| DABCO ® T-45 catalyst | 00.28 |
| Motor Oil 10W30 | 03.70 |
| LOXIOL ® G71S ester | 03.70 |
| Total | 100.00 |

Note:
Motor oil 10w30 and LOXIOL ® G71S ester were mixed homogeneously at 1:1 ratio and then added to the blend.

Isocyanate used as A-Component: RUBINATE® 7304 isocyanate, mixed with B-components at Index of 450.

Table 1 shows the physical properties of a typical polyurethane system used in the present one component open bath pultrusion process and has been compared with a typical resin system used in two component closed injection die process. The formulation used in this one-component (1C) polyurethane system is given Example 1 and for the two-component (2C) polyurethane system in Example 17. The data is compared with the resin system used for two-component injection die pultrusion processes.

TABLE 1
Typical Physical Properties of Liquid Resin
Systems Used in Pultrusion

| | | 1 Component | 2 Component Polyurethane | |
|---|---|---|---|---|
| PROPERTY | UNIT | Polyurethane | Isocyanate (A) | Polyol (B) |
| Appearance | — | Dark Yellow | Light Brown | Colorless |
| (Liquid) | | | | |
| Non Volatile | % | 95-98 | 95-100 | 95-100 |
| Viscosity | cps | 175-200 | 30-40 | 630-650 |
| SPG | — | 1.12-1.15 | 1.20-1.22 | 1.03-1.05 |
| Flash Point | ° C. | 255-260 | >230 | >230 |
| Gel Time @ | hour | Infinite | @ 1.11 ratio A/B ½ hour | |
| 25° C. | | | Reaction does not | |
| | | | go to completion | |
| Stability | months | 6-8 | 6-8 | 10-12 |

The formulation used for making neat plaques is the formulation used and described in Example 1 (1C Polyurethane) and Example 17 (2C Polyurethane). Table 2 shows the physical properties of the hand mixed neat resin plaques used for open bath one component pultrusion process (1C Polyurethane). The data is compared with the 2C Polyurethane neat (without reinforcement) system formulation. These plaques were made as follows: To the prepolymer blend of Example 1, 0.25% of DABCO® T-45 catalyst was added and then gently mixed with a tongue depressor for 10-15 seconds. Precautions were taken such that no air was whipped into the resin during mixing. The reaction mixture was then poured in a hot mold (0.4 mm thick) adjusted at 275±5° F. (135±5° C.). The mold was then closed and a pressure of 12-15 psi was applied. The mold was kept closed for 6 minutes after which the lid was removed. The cured samples were then kept at room temperature for 48 hours before they were analyzed for physical properties according to ASTM standard.

TABLE 2
General Physical Properties of Neat Resin
System Used During Pultrusion Study.

| | | 1C | 2C |
|---|---|---|---|
| PROPERTY | UNIT | POLYURETHANE | POLYURETHANE |
| SPG | — | 1.18-1.20 | 1.18-1.20 |
| Hardness | Shore “A” | 80-85 | 80-85 |
| Tensile | | | |
| ASTM D 263 | | | |
| Strength | Psi | 7200 | 10,800 |
| Elongation | % | 3.0-4.0 | 4.0-7.0 |
| Modulus | psi | 3.20 × 10⁵ | 4.75 × 10⁵ |
| Flexural | | | |
| ASTM D 790 | | | |
| Strength | psi | 10315 | NA |
| Modulus | psi | 2.9 × 10⁵ | 4.5 × 10⁵ |
| Shrinkage on | % | 0.5-1.0 | 0.5-1.0 |
| Cure | | | |

Table 3 shows the properties of the glass fiber reinforced polyisocyanurate-urethane composite pultruded at pull speed of 16 inches/minute using an open bath one component process according to the invention. The formulation used is given in Example 1.

TABLE 3
Properties of the glass fiber reinforced polyisocyanurate-urethane
composite using open bath one component process according to the invention.

| Properties | ASTM Method | Units | Parallel | Perpendicular |
|---|---|---|---|---|
| Specific Gravity | D 792 | | 1.52 | — |
| Glass content | D 2584 | % | 73.30 ± 0.40 | — |
| Hardness | D 2240 | Shore “D” | 75 | — |
| Tensile Properties | D 638 | | | |
| Before aging (@ Room Temp. 25° C.) | | | | |
| Tensile Modulus | | psi | 3076000 ± 15340 | — |
| Stress at Break | | psi | 65330 ± 4000 | — |
| Elongation | | % | 2.23 ± 0.21 | — |
| After aging (100% humidity at 70° C. for 7 days) | | | | |
| Tensile Modulus | | psi | 3076000 ± 16660 | — |
| Stress at Break | | psi | 54700 ± 190 | — |
| Elongation | | % | 2.21 ± 0.25 | — |
| Flexibility | D 790 | | | |
| Before aging (@ Room Temp. 25° C.) | | | | |
| Flexural Modulus | | psi | 2885891 ± 76316 | 1356238 ± 59049 |
| Stress at Break | | psi | 55533 ± 2663 | 20366 ± 1152 |
| Strain at Break | | % | 2.3 ± 0.4 | 2.4 ± 0.6 |
| After aging (100% humidity at 70° C. for 7 days) | | | | |
| Flexural Modulus | | psi | 2559227 ± 14415 | 884365 ± 34150 |
| Stress at Break | | psi | 45906 ± 2163 | 18592 ± 2163 |
| Strain at Break | | % | 2.8 ± 0.5 | 2.8 ± 0.4 |
| Impact Strength | D 256 | | | |
| Before aging (@ Room Temp. 25° C.) | | | | |
| Izod Impact (Notched) | | Ft-lbs/in | 35.1 ± 5.4 | 16.0 ± 2.0 |
| After aging (100% humidity at 70° C. for 7 days) | | | | |
| Izod Impact (Notched) | | Ft-lbs/in | 34.4 ± 3.0 | 12.1 ± 1.3 |
| Instrumented Impact | D 3763 | | | |
| Time to Max. Load | | Millie sec. | 4.05 ± 0.45 | — |
| Maximum Load | | lb. | 1222.86 ± 67.80 | — |
| Total deflection | | inch | 0.66 ± 0016 | — |
| Total Energy | | ft-lb. | 27.03 ± 1.22 | — |
| CLTE | D 696 | 10 × −6° C. | 7.44 ± 0.46 | 15.52 ± 1.45 |
| HDT @ 264 psi | D 648 | ° C. | 267.0 | — |
| Flammability | | | | |
| Vertical Flame Test | UL - 94 | — | VO | — |
| Oxygen Index | D 2863 | % | 31.8 | — |
| Smoke Density | E 662 | | | |
| Non-Flaming Mode | | | | |
| 90 sec. | | % | 1.0 | — |
| 240 sec. | | % | 23.0 | — |
| Max. Smoke | | % | 211.0 | — |
| Time to Max. Smoke | | minutes | 18.3 | — |
| Flaming Mode | | | | |
| 90 sec. | | % | 5.0 | — |
| 240 sec | | % | 105.0 | — |
| Max. Smoke | | % | 187.0 | — |
| Time to Max. Smoke | | minutes | 10.5 | — |
| Water Absorption | D 570 | % | 0.63 ± 0.05 | 0.44 ± 0.03 |

Table 4 shows the comparison of properties of the glass fiber reinforced polyisocyanurate-urethane composite pultruded by 1C and 2C at pull speed of 16 inches/minute using an open bath one component process and the closed injection die process respectively.

TABLE 4

| PULTRUSION | | | OPEN BATH PULTRUSION | | CLOSED INJECTION | |
|---|---|---|---|---|---|---|
| Properties | ASTM Method | Units | Parallel | Perpendicular | Parallel | Perpendicular |
| Specific Gravity | D 792 | — | 1.52 | — | 1.88 | — |
| Glass Content | D 2584 | % | 73.30 ± 0.40 | — | 74.20 ± 0.20 | — |
| Hardness | D 2240 | Shore “D” | 75 | — | 83 | — |
| Tensile Properties | D 638 | | | | | |

Before aging (@ Room Temp, 25° C.)

| | | | | | |
|---|---|---|---|---|---|
| Tensile Modulus | psi | 3076000 ± 15340 | — | 3687600 ± 13230 0 | — |
| Stress at Break | psi | 65330 ± 4000 | — | 78520 ± 2530 | — |
| Elongation | % | 2.23 ± 0.21 | — | 2.31 ± 0.19 | — |

After aging (100% humidity at 7° C. for 7 days)

| | | | | | | |
|---|---|---|---|---|---|---|
| Tensile Modulus | | psi | 3076000 ± 16660 | — | 3680400 ± 12110 0 | — |
| Stress at Break | | psi | 54700 ± 190 | — | 71490 ± 2970 | — |
| Elongation | | % | 2.21 ± 0.25 | — | 2.14 ± 0.35 | — |
| Flexibility | D 790 | | | | | |

Before aging (@ Room Temp, 25° C.)

| | | | | | |
|---|---|---|---|---|---|
| Flexural Modulus | psi | 2885891 ± 76316 | 1356238 ± 59049 | 3721345 ± 101322 | 1277991 ± 42498 |
| Stress at Break | psi | 55533 ± 2663 | 20366 ± 1152 | 73937 ± 5225 | 28035 ± |
| 1497 | | | | | |
| Strain at Break | % | 2.3 ± 0.4 | 2.4 ± 0.6 | 2.4 ± 0.2 | 2.9 ± 0.1 |

After aging (100% humidity at 70° C. for 7 days)

| | | | | | | |
|---|---|---|---|---|---|---|
| Flexural Modulus | | psi | 2559227 ± 14415 | 884365 ± 34150 | 3537866 ± 226326 | 1183466 ± |
| 199247 | | | | | | |
| Stress at Break | | psi | 45906 ± 2163 | 18592 ± 2163 | 67471 ± 4066 | 27768 ± |
| 4356 | | | | | | |
| Strain at Break | | % | 2.8 ± 0.5 | 2.8 ± 0.4 | 2.3 ± 0.5 | 3.1 ± 0.6 |
| Impact Strength | D 256 | | | | | |

Before aging (@ Room Temp, 25° C.)

| | | | | | |
|---|---|---|---|---|---|
| Izod Impact (Notched) | Ft-lbs./in | 35.1 ± 5.4 | 16.0 ± 2.0 | 45.4 ± 6.3 | 18.9 ± 1.4 |

After aging (100% humidity at 70° C. for 7 days)

| | | | | | | |
|---|---|---|---|---|---|---|
| Izod Impact (Notched) | | Ft-lbs./in | 34.4 ± 3.0 | 12.1 ± 1.3 | 45.4 ± 9.9 | 17.3 ± 2.3 |
| Instrumented Impact | D 3763 | | | | | |
| Time to Max. Load | | Millie sec. | 4.05 ± 0.45 | — | 4.44 ± 0.37 | — |
| Maximum Load | | lb. | 1222.86 ± 67.80 | — | 1559.04 ± 68.34 | — |
| Total deflection | | inch | 0.66 ± 0016 | — | 0.38 ± 0.03 | — |
| Total Energy | | ft-lb. | 27.03 ± 1.22 | — | 33.61 ± 0.20 | — |
| CLTE | D696 | 10 X =6°C. | 7.44 ± 0.46 | 15.52 ± 1.45 | 8.64 ± 1.40 | 29.96 ± |
| 1.19 | | | | | | |
| HDT @ 264 psi | D 648 | ° C. | 267.0 | — | 292.1 | — |
| Flammability | | | | | | |
| Vertical Flame Test | UL - 94 | — | VO | — | VO | — |
| Oxygen Index | D 2863 | % | 31.8 | — | 31.8 | — |
| Smoke Density | E 662 | | | | | |
| Non-Flaming Mode | | | | | | |
| 90 sec. | | % | 1.0 | — | 2.0 | — |
| 240 sec. | | % | 23.0 | — | 20.0 | — |
| Max. Smoke | | % | 211.0 | — | 135.0 | — |
| Time to Max. Smoke | | minutes | 18.3 | — | 20.0 | — |
| Flaming Mode | | | | | | |
| 90 sec. | | % | 5.0 | — | 2.0 | — |
| 240 sec. | | % | 105.0 | — | 20.0 | — |
| Max. Smoke | | % | 187.0 | — | 152.0 | — |
| Time to Max. Smoke | | minutes | 10.5 | — | 16.6 | — |
| Water Absorption | D 570 | % | 0.63 ± 0.05 | 0.44 ± 0.03 | 0.24 ± 0.01 | 0.24 ± |
| 0.04 | | | | | | |

The data shown in Table 4 demonstrate that the system used for the one component pultrusion foamed during the process (approximately 15-25%) thus reducing the density of the pultruded part. The foaming in pultrusion process will be of great importance to reduce the density of the final pultruded part.

There are many possible variations that can be made to the basic concept in order to optimize the properties of the final composite for particular applications. This includes, for example, the use of other types of prepolymers, different polyols, the inclusion of inert particulate fillers, chain extenders, and many other ways to modify the final properties of the final composite. These variations will be known to those skilled in the art.

What is claimed is:

1. A process for forming a fiber reinforced composite without the use of a closed impregnation die, comprising the steps of:
a) providing one or more polyisocyanate containing resins;
b) providing one or more porous reinforcing structures;
c) providing one or more catalysts suitable for promoting at least one polymer forming reaction of isocyanate groups;
d) providing at least one open bath containing the one or more polyisocyanate containing resins;
e) employing the open bath to at least partially impregnate at least one of the one or more porous reinforcing structures with the at least one polyisocyanate containing resin so as to form a prepreg, the prepreg characterized by having an exterior resin surface facing away from the reinforcing structure and an interior resin surface facing the reinforcing structure;
f) disposing an effective amount of at least one of the one or more catalysts at a location selected from:
i) the interior resin surface,
ii) the exterior resin surface, and
iii) a combination of the interior and the exterior resin surfaces, in order to form a catalyzed prepreg;
g) providing one or more curing apparatus capable of delivering a combination thermal and mechanical energy to the catalyzed prepeg; and
h) employing the at least one curing apparatus to facilitate the curing of the catalyzed prepreg by the application of a combination of thermal and mechanical energy to the prepreg;
under the proviso that the polyisocyanate containing resin is not fully cured and is in a flowable state at the time that the combination of thermal and mechanical energy is applied to the catalyzed prepreg, and under the further proviso that the catalyst disposed on the prepreg is not homogeneously distributed within the bulk of the polyisocyanate containing resin at the time that the combination of thermal and mechanical energy is applied to the catalyzed prepreg.

2. The process according to claim 1, wherein at least one of the one or more catalyst used in the preparation of the catalyzed prepreg remains at least partially phase separated from the polyisocyanate containing resin until the catalyzed prepreg enters the curing apparatus.

3. The process according to claim 1, wherein all of the one or more catalyst used in the preparation of the catalyzed prepreg have boiling points greater than 100° C. at 1 atmosphere pressure.

4. The process according to claim 3, wherein all of the one or more catalyst used in the preparation of the catalyzed prepreg have boiling points greater than 150° C. at 1 atmosphere pressure.

5. The process according to claim 2, wherein the process is a pultrusion process and wherein the curing apparatus used to produce the fiber reinforced composite includes a curing die of a pultrusion machine and the one or more porous reinforcing structures comprises fibers of at least one meter in length.

6. The process according to claim 2, wherein at least one of the at least partially phase separated catalysts used in preparing the catalyzed prepreg comprises at least one compound selected from the group consisting of alkali metal salts of carboxylic acids, alkaline earth metal salts of carboxylic acids, and combinations of these.

7. The process according to claim 5, wherein the curing die is the primary curing apparatus.

8. The process according to claim 7, wherein the curing die is the sole curing apparatus.

9. The process according to claim 1, wherein a catalyst is applied to the one or more porous reinforcing structures before the one or more polyisocyanate containing resins is applied to the one or more reinforcing structures.

10. The process according to claim 1, wherein a catalyst is applied to the at least one prepreg after the polyisocyanate containing resin has been applied thereto.

11. The process according to claim 10, wherein the catalyst is applied by spraying directly onto the exterior resin surface.

12. The process according to claim 9, wherein the catalyst is applied to the one or more reinforcing structures by at least one method selected from the group consisting of spraying and dip coating.

13. The process according to claim 12, wherein the catalyst treated reinforcing structure is dried to remove all volatile species having boiling points of 150° C. or less at 1 atmosphere pressure, before any of the one or more polyisocyanate containing resins are applied to the reinforcing structure.

14. The process according to claim 1, wherein the one or more catalyst is applied both to the reinforcing structure prior to the application of the one or more polyisocyanate containing resins, and to the prepreg after the polyisocyanate containing material has been applied.

15. The process according to claim 2, wherein the curing apparatus used in preparing the fiber reinforced composite comprises a heated press.

16. A fiber reinforced composite article produced according to the process of claim 15, selected from the group consisting of sheet molding compound (SMC) composite, bulk molding compound (BMC) composite, composite produced by hand layup, composite produced by filament winding, and composite produced by resin transfer molding.

17. The fiber reinforced composite article according to claim 16, wherein the fibers used to reinforce the composite comprise fibers of greater than 0.1 meters in length.

18. The fiber reinforced composite article according to claim 17, wherein the fibrous reinforcing material comprises at least one mat.

19. A pultruded part produced according to the process of claim 5.

20. The pultruded part according to claim 19, wherein the fibrous reinforcing structure used in the preparation of the part comprises at least one mat.

21. A composite article produced according to the process of claim 1, wherein the composite comprises a plurality of urethane groups.

22. A composite article produced according to the process of claim 1, wherein the composite comprises a plurality of isocyanurate groups.

23. The process according to claim 1, wherein the one or more polyisocyanate containing resins on the catalyzed prepreg is still liquid and still contains unreacted isocyanate groups at the time the catalyzed prepreg enters the curing apparatus.

24. The process according to claim 5, wherein the one or more polyisocyanate containing resins on the catalyzed prepreg gels inside the curing die of the pultrusion machine and a solid pultruded part free of wet spots emerges from the curing die.

25. The process according to claim 1, wherein the principle reactions that take place during the curing are selected from the group consisting of urethane formation, isocyanurate formation, and combinations of these.

26. The process according to claim 25, wherein the principle reaction that takes place during the cure is isocyanurate formation.

27. The process according to claim 1, wherein the polyisocyanate containing resin used in preparing the composite consists essentially of an MDI series isocyanate composition which is liquid at 25° C. and has a viscosity at 25° C. in the range of from greater than 100 cps to less than 1000 cps.

28. The process according to claim 27, wherein the MDI series isocyanate composition is a mixture of one or more isocyanate terminated prepolymers and one or more monomeric isocyanates of the MDI series.

29. The process according to claim 1, wherein the sole means used for the impregnation of the porous reinforcing structure with the polyisocyanate containing material is the at least one open bath wherein the at least one bath contains a gas filled head space maintained at ambient pressure.

30. The process according to claim 29, wherein a single open bath is used for impregnation of the porous reinforcing structure with the one or more polyisocyanate containing resin.

31. A process for forming a fiber reinforced composite without the use of a closed impregnation die, consisting essentially of:
a) providing one or more polyisocyanate containing resins;
b) providing one or more porous fiber reinforcing structures;
c) providing one or more catalysts suitable for promoting at least one polymer forming reaction of isocyanate groups;
d) providing at least one open bath;
e) employing the open bath to at least partially impregnate at least one of the porous fiber reinforcing structures with at least one bath containing the one or more polyisocyanate containing resin so as to form a prepreg, the prepreg characterized by having an exterior resin surface facing away from the reinforcing structure and an interior resin surface facing the reinforcing structure;
f) disposing an effective amount of at least one of the one or more catalysts suitable for promoting at least one polymer forming reaction of isocyanate groups at a location selected from the group consisting of:
i) the interior resin surface,
ii) the exterior resin surface, and
iii) a combination of the interior and the exterior resin surfaces, in order to form a catalyzed prepreg;
g) providing one or more curing apparatus capable of delivering a combination of thermal and mechanical energy to a curing substrate; and
h) employing the at least one curing apparatus to facilitate the curing of the catalyzed prepreg by the application of a combination of thermal and mechanical energy to the prepreg;
under the proviso that the polyisocyanate containing resin is not fully cured and is in a flowable state at the time that the combination of thermal and mechanical energy is applied to the catalyzed prepreg, and under the further proviso that the catalyst disposed on the prepreg is not homogeneously distributed within the bulk of the polyisocyanate containing resin at the time that the combination of thermal and mechanical energy is applied to the catalyzed prepreg.

32. The process according to claim 31, wherein the composite is made by one component open bath pultrusion; the principle reaction during cure is isocyanurate formation; the reinforcing structure is selected from the group consisting of continuous glass fibers, mats made from glass fibers of greater than one meter in average length, and combinations of these; and the polyisocyanate containing material is an MDI composition containing isocyanate terminated prepolymers and monomeric isocyanates of the MDI series, the isocyanate composition being liquid at 25° C. and having a viscosity at 25° C. of between 200 cps and 800 cps.
